(19) United States
(12) Patent Application Publication
(10) Pub. No.: US 2023/0382786 A1
(43) Pub. Date: Nov. 30, 2023

(54) MULTIVALENCE CERIUM OXIDE NANOPARTICLES IN SOLUBLE BORATE GLASS MATRICES FOR TARGETED RELEASE

(71) Applicant: Kennesaw State University Research And Service Foundation, Inc., Kennesaw, GA (US)

(72) Inventors: Kisa Ranasinghe, Marietta, GA (US); Rajnish Singh, Marietta, GA (US); Delbert Day, Rolla, MO (US)

(21) Appl. No.: 18/331,008

(22) Filed: Jun. 7, 2023

Related U.S. Application Data
(62) Division of application No. 16/850,528, filed on Apr. 16, 2020.
(60) Provisional application No. 62/834,801, filed on Apr. 16, 2019.

(51) Int. Cl. C03C 3/15; C01F 17/235; C03C 12/00

(52) U.S. Cl. CPC C03C 3/15; C01F 17/235; C03C 12/00; C01P 2004/64; C03C 2203/10

(57) ABSTRACT

A composition comprising glass containing both trivalent cerium oxide and tetravalent cerium oxide states nano particles. A soluble sodium borate glass comprising cerium oxide that is stable against crystallizations, the cerium oxide comprising both trivalent Ce³⁺ (Ce₂O₃) and tetravalent Ce⁴⁺ (CeO₂) states, wherein the cerium oxide nano particles are configured to be released when the glass is dissolved.

### CROSS REFERENCE TO RELATED APPLICATIONS

This application is a divisional of U.S. Ser. No. 16/850,528 filed Apr. 16, 2020, which claims priority to and the benefit of U.S. Ser. No. 62/834,801 filed Apr. 16, 2019, each of which is expressly incorporated by reference herein in its entirety.

### BACKGROUND

Cerium oxide (CeO₂) has been of much interest in recent years due to its many applications such as catalyst, scintillators, fuel cells, oxygen sensors, and bio materials. Unlike other elements in the lanthanide group, Ce atom can exist in both trivalent Ce³⁺ (Ce₂O₃-reduced) and tetravalent Ce⁴⁺ (CeO₂-oxidized) states as it has two partially filled subs-shells, 4f and 5d, allowing several excited states Cerium oxide is usually in the form of Ce⁴⁺ with stable electronic configuration where every oxygen atom surrounded by the cerium atom is in a tetrahedral position. The trivalent Ce³⁺ is originated from the transition of 5d levels to the 2f ground state, but Ce³⁺ may lose the 4f electron to form Ce⁴⁺ by direct ionization or by trapping a hole

Ce³⁺+h⁺→Ce⁴⁺

Ce⁴⁺+e⁻→Ce³⁺.

In order to understand this multi-valance existence, an Arrhenius-based equation is modeled for the high temperature reduction and oxidation of CeO₂. Since this reaction

$$C e {O}_{2} ⇌ Ce {O}_{2 - δ} + \frac{δ}{2} {O}_{2}$$

is an equilibrium reaction, both reduction and oxidation reactions take place at any given time. This transformation ability in mix valence state of ceria nanoparticles gives rise to many biological and industrial applications. When Cerium oxide is doped in borate glass, a significant amount cerium oxide is observed in the form of less stable Ce³⁺ configuration with oxygen vacancy due to 5d→4f emission. Hence, much attention was given when glass is doped with cerium due to this uncharacteristic transition between the mixed-valence-state of cerium. When CeO₂ is doped in the glass, trapped electron centers and trapped hole centers were inhibited and these multi-valance Ce³⁺ and Ce⁴⁺ coexist within the glass network giving rise to new properties and a new range of bio-glasses due to these multivalences in ceria nanoparticles.

On the other hand, cerium oxide nanoparticles have been found to have antioxidant properties and are able to scavenge and neutralize toxic radicals generated in living systems by oxygen consuming processes as well as environmental conditions. The accumulation of these toxic radicals has been implicated in a host of diseases like cancer, diabetes, Alzheimer's and inflammatory conditions.

Currently, the formation of polyvalent nanoceria, within the glass, with specific ratio of Ce³⁺/Ce⁴⁺ which is controlled during the synthesis is not well understood. Moreover, no studies have addressed what ratio is required for cell survival and antioxidant properties, even though there is an understanding of cerium oxide ratios affecting antioxidant activity.

Moreover, it may be understood that nanoceria may be prepared by different synthesis methods including, but not limited to, sol-gel method, hydrothermal method, ball milling, microwave method, spray pyrolysis, thermal decomposition. A more recent approach to synthesizing nanoparticles is the use of organic in such as plant extracts and nutrients. However, all of these methods provide a particular nanoparticle with a large range of sizes. There is also no optimal method of storing multivalence nanoparticles for long periods of time without loss of function.

### SUMMARY

The present disclosure may relate to a soluble sodium borate glass comprising cerium oxide that is stable against crystallizations, the cerium oxide comprising both trivalent Ce³⁺ (Ce₂O₃) and tetravalent Ce⁴⁺ (CeO₂) states, wherein the cerium oxide nano particles are configured to be released when the glass is dissolved.

The present disclosure relates to the creation of a soluble and biologically compatible glass that forms multivalent Ce³⁺ (Ce₂O₃) and Ce⁴⁺ (CeO₂) nanoparticles. The successfully invented borate bioactive glass functions as a creator and carrier of mixed valence nanoceria. Furthermore, a ratio of Ce³⁺ and Ce⁴⁺ nanoparticles can be controlled, for example, by modulating the glass synthesis parameters and these specific ratios are hermetically sealed within the glass. This synthesized glass has the capacity to dissolve in an aqueous media and release the mixed valence nanoceria. Studies have shown that the ratio of Ce³⁺/Ce⁴⁺ cerium oxide nanoparticles can regulate their biological activity and have many applications, such as in the treatment of disease states. However, the ratio of Ce³⁺/Ce⁴⁺ cerium oxide nanoparticles may be controlled for various applications and uses. Creating nanoparticles through soluble glass design would advance the fields of chemical and biomaterials industry with wide-ranging applications in scintillation material synthesis, three-way catalyst for catalytic converters, fuel cells that minimize the environmental pollution, novel ionic fluids for propulsion, solar cells that block UV transmission as well applications in non-linear materials for photonic devices and biomaterials. The present disclosure may add a new dimension to bioactive glass applications and provide a novel bioactive glass that is the creator and carrier of nanoceria with desired ratios of Ce³⁺ (Ce₂O₃) and Ce⁴⁺ (CeO₂) nanoparticles. The glass can also be doped with other materials such as metal oxides to create therapeutic nanoparticles and expand the range of applications.

Chemical synthesis of nanoparticles are multi-step processes requiring expensive reagents, toxic solvents and chemicals and lengthy procedures that yield nanoceria with inconsistent Ce³⁺ and Ce⁴⁺ ratios and particle sizes. Synthesized nanoparticles are unstable over long periods of storage. Agglomeration, modification to surface charge may occur and all of these modifications can affect the final function of the nanoceria.

The newly invented bioactive glass of the present disclosure is first of its kind that is able to produce multivalence nanoparticles embedded within the glass matrix with controlled ratios. This invention will provide an easier alternative to synthesis of mixed valence nanoceria with specific Ce³⁺ and Ce⁴⁺ ratios. The nanoceria produced with be protected within the glass, its valences sealed within the glass and not affected by external conditions. The nanoceria will be released only when the glass is dissolved. The biggest advantage of the proposed product is that the synthesis of mixed valence nanoceria and its packaging into a delivery system will be a one step process and not multistep. Some applications require specific ratios of Ce³⁺ and Ce⁴⁺ and it will be possible to synthesize such specific ratios of mixed valence nanoceria to suit a particular application by controlling conditions during the glass synthesis.

### BRIEF DESCRIPTION OF THE DRAWINGS

The Appendices attached hereto are hereby incorporated by reference in their entirety and form a part of the specification.

The following drawings show generally, by way of example, but not by way of limitation, various examples discussed in the present disclosure. In the drawings:

FIG. 1 shows an example plot of DSC thermographs of (a) glass transition (b) crystallization and (c) melting temperature for S1 to S 6 glass with increasing CeO₂ content.

FIGS. 2A-C show example images (a) Low resolutions (b) Higher resolution TEM image of cerium oxide nanoparticles from S6 glass that was dissolved in DI water at 37° C. (c) size of the cerium oxide nanoparticles that was created within the S6 glass that was dispersed in DI.

FIGS. 3A-B show (A) Atomic distance of CeO₂ nanoparticles recovered from S6 glass after it was dissolved in DI water for 7 hrs. (B) size of CeO₂ nanoparticles from S6 glass after dissolved in DI water 2 hrs.

FIG. 4 shows an example Ce L3 edge XANES spectrum for the reference crystalline compounds CeF₃(Ce³⁺) (---) and CeO₂(Ce⁴⁺) (---) with (a) trivalent (Ce³⁺) due to 5d→4f emission, and tetravalent reference (Ce⁴⁺) due to 2p→5d with final state (b) 2p4f15d1 (c) with 2p5d.

FIG. 5 shows an example XANES spectrum for the glasses containing from 0.01 to 0.05 mols of CeO₂ compared to the spectrum for pure CeF₃ (Ce³⁺) and pure CeO₂(Ce⁴⁺)

FIGS. 6A-B show an example XANES spectra for S6 glass with 0.05 mols of (a) cerium with different melting temperature and melting time (b) melted with different raw materials

FIGS. 7A-B show an example FTIR spectra (a) S1 with increased cerium content (b) S6 glass with different melting time and temperature

FIG. 8 shows example Ce³⁺ and Ce⁴⁺ amounts in the glasses containing from 0.01 to 0.05 mol % analyzed from XANES spectrums.

FIG. 9 shows example Ce³⁺ and Ce⁴⁺ amounts in the glass containing 0.05 mol % for different melting temperatures, melting time, and raw materials analyzed from XANES spectrums.

### DETAILED DESCRIPTION

A borate glass containing varying amounts of cerium (IV) oxide was successfully prepared with both trivalent Ce³⁺ (Ce₂O₃) and tetravalent Ce⁴⁺ (CeO₂) states nano particles in 2-5 nm in size. X-ray absorption near edge spectroscopy measurement was used to investigate coexistence of the multivalence in the borate glass. Significant changes in the Ce⁺³ and Ce⁺⁴ were observed when the glass was melted with different melting parameters as well as different raw materials. Glass made with borax that contained 0.05 mols of CeO₂ melted at 1100° C. for 3 hrs yields the highest Ce³⁺ while the glass containing 0.03 mols of CeO₂ melted for 1100° C. for 1 hr. yields a higher amount of Ce⁴⁺. TEM micrographs confirm the coexistence of Ce₂O₃ and tetravalent CeO₂ nano particles in the glassy matrix. FTIR measurements suggest that the CeO₂ in the glass acts as both a glass-former and a glass modifier.

In the present disclosure a novel glass that is stable and soluble was synthesized by doping with Ce₂O to produce both trivalent Ce³⁺ (Ce₂O₃) and tetravalent Ce⁴⁺ (CeO₂) nanoparticles. These mixed-valence-state nanoparticles are hermetically sealed within the glass with a specific amounts of Ce³⁺ and Ce⁴⁺ using a solid-state reaction and further these nano particles are releases when dissolved in aqueous solution.

The glass of the present disclosure may be changed by adding reducing agents such as carbonates and sulfates to increase Ce³⁺ or adding oxidizing chemicals (e.g., nitrates) to reduce Ce³⁺. As shown herein, CeO₂ may be used. Alternatively or additionally the glass may comprise CePO₄, Ce(NO3)₃ to achieve different amount of Ce³⁺ and Ce⁴⁺.

Potential Applications of Borate glass with multivalent cerium oxide nanoparticle (CeONP) Ce atom can exist in both trivalent Ce³⁺ (Ce₂O₃ reduced) and tetravalent Ce4⁺ (CeO₂ oxidized) states as it has two partially filled subs-shells, 4f and 5d, allowing several excited states. When combine with oxygen in a nanoparticle formulation, cerium oxide emerges as a fascinating material. In the experiment, relative amount of cerium ions, Ce3⁺ and Ce4⁺ is controlled and made available within a soluble glass with sealed Ce³⁺ and Ce⁴⁺ ratios indefinitely. Further, these cerium oxide nanoparticles (CeONP) is released when dissolved. The TEM microscopy images of nanoparticles extracted when the glass is dissolved provide direct evidence of the coexistence of Ce₂O₃ and CeO₂ nanoparticles.

As an example, this cerium oxide nanoparticle (CeONP) has been used prolifically in various engineering and biological applications, and by combining the attributes of glass and CeONP at least the following applications may make use of borate glass doped with nanoceria:
1. Three-Way-Catalysts (TWC)—During automobile emission, three pollutants, HC, CO and NO are simultaneously removed by three-way-catalysts to Co₂ and water by oxidation. It has been understood that ceria nanoparticles have much better performance when used in catalytic converters. For example, mixing ceria particles with diesel is known to dramatically reduce soot in diesel exhausts. In this process typically CeO₂ is used but the glass of the present disclosure can be optimized to provide the necessary oxidation ratio Ce³⁺ Ce⁴⁺ to provide the thermal stability that enhances the catalytic reaction. This could lead to more-efficient catalytic converters and cleaner air.
2. Fuel cells—Solid oxide fuel cells have been widely investigated for energy and environmental pollution problems by directly transforming chemical energy into electric power. Ceria has been studied as a possible electrolyte due to its high ionic conductivity. Still, transformation between Ce³⁺ and Ce⁴⁺ ions is a major problem. With nanoparticles embedded in the glass sealed with amounts of Ce³⁺ and Ce⁴⁺, the glass of the present disclosure will be able to overcome these drawbacks and can be used as an interface to provide the necessary ion diffusion.
3. Ionic Solvent—Hydroxylammonium nitrate (HONH2) is an Ionic fluid that has been identified as an environmentally friendly, high performing substance used for space and rocket propulsion. It has been identified that a specific form of an in situ Ce³⁺/Ce⁴⁺ ion couple in ceria is critical in deciding the reactivity of HONH2 decomposition generating free radicals ONH2, which are rapidly oxidized to nitrate by the presence of ceria nanoparticles. The synthesized glass can be used to provide this optimized Ce³⁺/Ce⁴⁺ to create a further higher-performing monopropellant.
4. New scintillators—Scintillators convert high-energy particles such as X-ray photons into visible light where the visible light is detected by photomultipliers and translated into an electrical/digital signal. With the effect of the controlled photocatalyst via covalent nanoceria, the synthesized glass will be a promising candidate for potential applications in both high-energy physics and X-ray Computerized Tomography (CT) for industrial and medical imaging.
5. Solar-cells—With the ozone layer thinning out considerable attention has been given to developing materials that block or reduce ultraviolet (UV) transmission. A varied ratio of Ce³⁺ and Ce⁴⁺ in the borate glass of the present disclosure could be used to block (UV) transmission when combined with aluminosilicate. The aluminosilicate will produce a different variation of the borate glass with advanced network structure preventing dissolution. Further, this version of the borate glass series can be used as a novel coating/covers for solar cells that enhances the UV absorption and radiation stability
6. Commercial development of nanoceria—the glass of the present disclosure can create multivalent CeONP powder in 2-5 nm particles size that are commercially not available

The present disclosure describes the creation of a soluble glass containing mixed valence cerium oxide nanoparticles. When dissolved, the glass releases multivalent Ce³⁺ (Ce₂O₃) and Ce⁴⁺ (CeO₂) nanoparticles and the presence of Ce³⁺ and Ce⁴⁺ in the nanoparticle gives it the unique property to neutralize free radicals and function as an antioxidant. The resulting product is a novel glass that has sealed within it specific ratios of Ce³⁺ and Ce⁴⁺ and can function as a ready to use biocompatible, antioxidant material.

As an example, nanoceria containing glass can neutralize free radicals by mimicking the activity of catalase, an important anti-oxidant enzyme in living systems. Catalase mimetic activity of the nanoceria containing glass was tested using a amplex red, a reagent that is able to detect hydrogen peroxide, a common free radical generating compound in living cells. Glass without nanoceria does not have catalase activity, however, glass containing nanoceria has catalase activity. The concentration of cerium (IV) oxide in the glass is 250 PM. These results clearly show that the glass containing nanoceria is able to degrade hydrogen peroxide into water and oxygen, just like catalase does in living cells.

As an example, nanoceria containing glass can kill bacteria such as Staphylococcus Aureus and Escherichia Coli. The antimicrobial activity of the nanoceria containing glass was tested on two different clinically relevant strains of bacteria—Escherichia Coli and Staphylococcus Aureus. Increasing amounts of glass containing nanoceria (concentration of CeO₂ in micromolar—μM is indicated) inhibit the growth of both strains of bacteria.

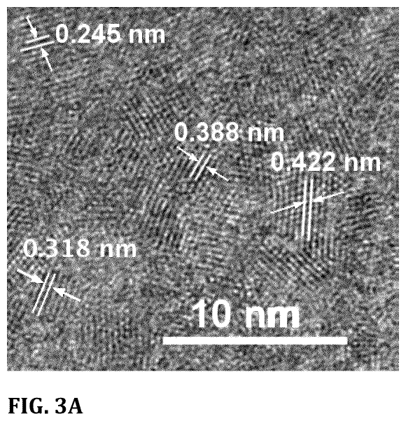

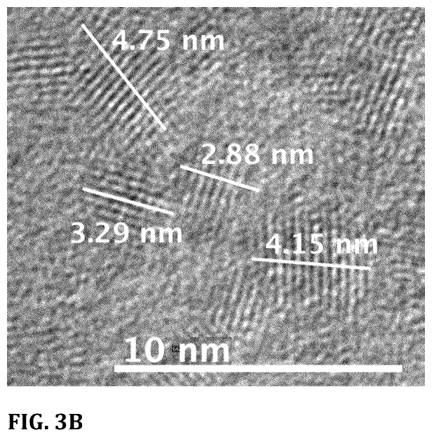

As an example, nanoceria containing glass is biocompatible with mammalian cells. The effect of nanoceria containing glass was determined on mammalian cells using the MTS assay. Epithelial cells were treated with nanoceria containing glass with different concentrations of cerium (IV) oxide. As seen in FIG. 3, after 16 hours of treatment, cells treated with 290-871 μM CeO₂ were still metabolically active at around 80-90% compared to the control (no treatment), while cells treated with the base glass with no ceria showed a significant decrease in cell activity.

The bioactive glass of the present disclosure that contains mixed valence cerium oxide nanoparticles may dissolve and release nanoparticles has antioxidant activity has anti-microbial activity against the bacteria tested is biocompatible with tested mammalian cells. These properties may be implemented for:
a. Implant coatings—Glass can be used to coat tissue implants. Glass containing antioxidant and antimicrobial nanoceria could be potentially used to
   i. Improve biocompatibility of implants
   ii. Reduce inflammation at tissue sites because of antioxidant activity
   iii. Reduce microbial contamination at tissue sites
   iv. Accelerate tissue healing
b. Bandages for wounds—Glass can be processed into fibers that can be used as dressing for wounds. Antioxidant and antimicrobial activities would accelerate wound healing as well as prevent microbial infections.
c. Synthesis of anti-microbial glass equipment for hospitals—antibiotic resistance is a growing concern in the healthcare industry and using glass that has anti-bacterial activity to create glassware for hospitals as well as other equipment would be highly beneficial.
d. Biocompatible material for tissue engineering—bioactive glass is extensively used as scaffolds in both hard and soft tissue regeneration. Glass with antioxidant properties would provide a biocompatible material with additional properties that would enhance the effect of the glass at tissue sites.

As an example, in order to study the cerium valence states in the novel glass, in-situ valence states of Ce³⁺ and Ce⁴⁺ was measured using X-ray Absorption Near Edge Spectroscopy (XANES) obtained at the Ce LIII-edge for all the glass samples using 81D ISS beam line at the National Synchrotron Light Source NSLS II at Brookhaven National Lab. XANES spectroscopy can measure in-situ valence states of redox-sensitive elements such as cerium with much higher accuracy when compared to X-ray photoelectron spectroscopy which can reduce additional Ce⁴⁺ to Ce³⁺ under high-vacuum, thus overestimating the Ce³⁺ concentration. XANES can circumvent this limitation and therefore is a more appropriate technique to study the in-situ valence states of Ce⁺³ and Ce⁺⁴. Synchrotron based determinations of Ce³⁺/Ce⁴⁺ in materials have traditionally used Ce L₃-edge XANES which involves a 2p→5d transition located around 5.7 keV. In this experiment the 8-ID ISS beam line with an energy range of 4.9 keV-36 keV was used to measure Ce L₃ edge XANES. This method was also used to compare the Ce⁺³ and Ce⁺⁴ amounts in the novel glass when different amounts of cerium oxide are used as well as different raw materials. Further, the glass was physiochemically characterized and the released nanoparticles were investigated via transmission electron microscopy.

### Experimental Method:

A sodium borate glass with molar composition of Na₂O·2B₂O₃ was used as a parent glass (S1 Glass in Table 1) to create a series of borate glass doped with varying concentrations of CeO₂ (Na₂O·2B₂O₃·xCeO₂). Each glass was melted in a platinum crucible in a different atmosphere such as air, argon and nitrogen. The raw materials, boron trioxide and sodium carbonate were obtained from Alfa Aesar with 99.99 purity. Another group of glasses S6-1 to S6-5 with 0.05 mol % of cerium (IV) oxide, melted at 1100° C., 1200° C. and 1300° C. for 1, 2, and 3 hrs contained borax (sodium tetraborate decahydrate) as raw materials (Table 2). Additionally, borate glass-using with different raw materials such as sodium tetraborate (S13) and boric acid (S14) were produced with different amounts of Ce⁺³ and Ce⁺⁴. Further, instead of cerium (IV) oxide, cerium (III) fluoride was also used as a source of cerium. Glass S-12 was melted with CeF₃, rich in Ce³⁺ instead of CeO₂ along with boron trioxide and sodium carbonate. Each glass was melted in at temperatures 1000° C., 1100° C. 1200° C., and 1300° C. and times 1, 2, 3, 5, 8, 10, 18, and 24 hours. Some compositions were re-melted and some were annealed to obtain different reduced states. Each melt was given a quick stir and was poured and quenched between two steel plates. The quenched glass was then ground in to powder where the particle sizes ranged from 30 μm to 500 μm. Each poured glass was investigated via optical microscopy to observe possible undissolved CeO₂ particles in the glass.

TABLE 1
Compositional Changes in Glass Samples

| Sample | Amount | Melted | Melted Time |
|---|---|---|---|
| Labeled | of Cerium | Temperature(° C.) | (hrs) |
| Glass S1 | 0 | 1100 | 1 |
| Glass S 3 | 0.02 mol % CeO₂ | 1100 | 1 |
| Glass S 4 | 0.03 mol % CeO₂ | 1100 | 1 |
| Glass S 5 | 0.04 mol % CeO₂ | 1100 | 1 |
| Glass S 6 | 0.05 mol % CeO₂ | 1100 | 1 |
| Glass S 7 | 0.06 mol % CeO₂ | 1100 | 1 |
| Glass S 8 | 0.07 mol % CeO₂ | 1100 | 1 |
| Glass S 9 | 0.08 mol % CeO₂ | 1100 | 1 |
| Glass S 10 | 0.09 mol % CeO₂ | 1100 | 1 |

TABLE 2
Example Glass Composition/Identification with change
in melting temperature and meting time for glass melted
in the air atmosphere that contained borax.

| | Melting | |
|---|---|---|
| | Temperature | Melting Time |
| Glass ID | (° C.) | (hrs.) |
| Glass S 6-1 | 1100 | 1 |
| Glass S 6-2 | 1100 | 2 |
| Glass S 6-3 | 1100 | 3 |
| Glass S 6-4 | 1200 | 1 |
| Glass S 6-5 | 1300 | 1 |

TABLE 3
Glass Composition/Identification with change in raw materials,
melted at 1100° C., for 1 hr. in the air atmosphere

| Glass ID | Raw Materials |
|---|---|
| Glass S6-1 | 0.05 mol CeO₂ with Borax |
| Glass S13 | 0.05 mol CeO₂ with Tetraborate |
| Glass S14 | 0.05 mol CeO₂ with Boric Acid |
| Glass S12 | 0.05 mol CeF₃ with Borax |

### Extracting Nano Particles and Observing Via TEM

A 625 mg of glass powder with a particle size 150 μm was dissolved in 25 ml distilled water (DI) overnight at 37° C. The solution was then centrifuge and the nanoparticle suspension was separated and sonicated for 5 minutes with fresh DI water. Then the solution was centrifuged and the process was repeated several times to completely remove the glassy substrate. The final sonicated solutions that included the cleaned nano particles were used to examine the microstructure using Transmission electron Microscope (FEI Tecnai 30 TEM). A small drop of the nano particle solution is then placed on the TEM copper grid followed by overnight drying. The sizes of the nanoparticles as well as the inter atomic distances of these ceria nano particles was observed and measured.

### Thermal Analysis

A DSC Q600 differential Thermal analyzer was used to measure the glass transition temperature (Tg), crystallization peaks (Tc), and melting point (Tm) of each glass A 30 mg sample of glass powder (400-450 μm) was measured and tested by heating the sample to 900° C. at 20° C./min. The entire set of borate glass was tested, and the thermographs were obtained for comparing the Tg, Tc, and Tm with the parent S1 glass and to measure the Hurby parameter of glass stability against crystallization.

### XANES Spectroscopy

XANES measurements were performed at Ce L3 edge XAS, at NSLS-II, using the 8-ID ISS beamline with an energy range of 4.9 keV-36 keV. The glasses were prepared by a pellet press to create a smooth flat dense sample of 2-3 mm thickness. The data was collected and analyzed using Athena software to calculate Ce³⁺ and Ce⁴⁺ concentrations.

### FTIR Absorption Spectroscopy

To determine the effects of Cerium Oxide on glass structure, FTIR absorption spectra were recorded at room temperature for all the samples between 600-4000 cm⁻¹ using a Perkin Elmer ATR-IR Spectrum Two Spectrometer. Instrument was manipulated, and the data was collected using “Spectrum 10” software.

### Results:

### Thermal Analysis:

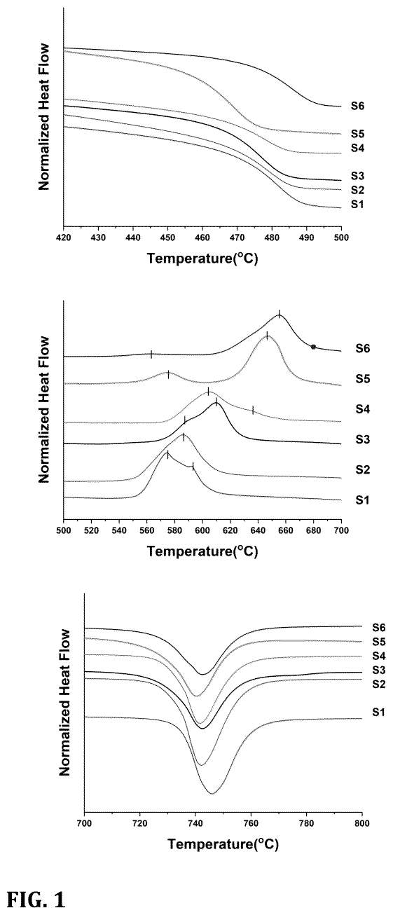

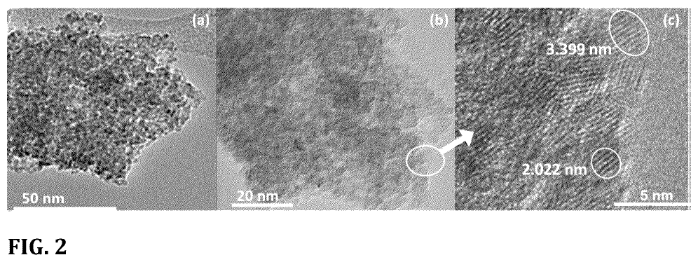

Each glass was analyzed using Differential Scanning Calorimetry (DSC) to observe any changes in glass transition, (Tg), crystallization (Tc), and melting point (Tm), as the doping concentration of cerium (IV) oxide changes. All thermographs showed a similar glass transition temperature region while some glass samples showed a dual exothermic crystal peak for some concentrations. The DSC thermographs for all the cerium concentrations are shown in FIG. 1, where thermograms have been normalized with respect to 1 mg of mass for all the glasses for better comparison. The glass transition temperature, Tg falls within the same temperature range for all the glasses except S5. The crystallization temperature (Tc) changes as the cerium content in the glass increases. All the glasses have a higher crystallization temperature Tc than the parent (S1) glass without cerium. There are two crystallization peak temperatures; TPk for S1 glass at 575° C. and 592° C. The second TPk of the parent glass was significantly smaller and the dominant peak temperature increases with increasing cerium content. All glass samples have dual crystallization peaks and the peak temperatures are labeled in Table 4 with the exception the S2 glass which was melted with 0.01 mols of CeO₂. The melting temperature Tm is similar in all the glass compositions.

TABLE 4
Glass transition, (T_{g}), Crystallization on-set (T_{c}), Crystallization Peaks
(T_{Pk1}) and (T_{Pk2}) and melting (Tₘ) temperatures (±0.5° C.), as the concentration
of CeO₂ increases in the glass along with the calculated Hruby parameter, KH:

| Glass ID | T_{G}(° C.) | T_{C}(° C.) | T_{Pk1}(° C.) | T_{Pk2}(° C.) | Tₘ(° C.) | K_{H} |
|---|---|---|---|---|---|---|
| S1 | 471 | 553 | 575 | 592 | 724 | 0.48 ± 0.003 |
| S2 | 469 | 364 | 586 | — | 711 | 0.65 ± 0.004 |
| S3 | 467 | 570 | 589 | 610 | 710 | 0.74 ± 0.004 |
| S4 | 468 | 572 | 605 | 637 | 718 | 0.71 ± 0.004 |
| S5 | 459 | 553 | 575 | 645 | 670 | 0.80 ± 0.006 |
| S6 | 474 | 607 | 562 | 655 | 712 | 1.27 ± 0.008 |

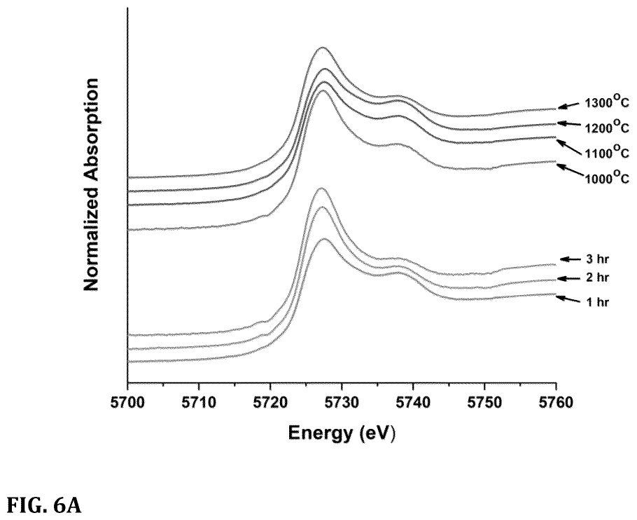

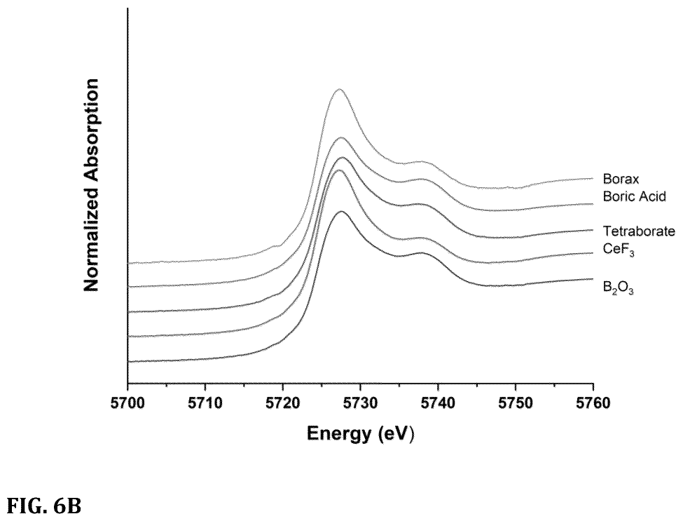

Coexistence of the mixed-valence-state Ce³⁺ (Ce₂O₃) and Ce⁴⁺ (CeO₂) nanoparticles were observed. S6 glass was dissolving in DI water for different hours to determine the presence of ceria nanoparticles and TEM images for 2 hrs and 7 hrs are shown in FIGS. 3 (a) and (b) respectively with (a) shows a fairly low magnification image with agglomerated ceria nano particles while figure (b) shows a high resolution image with ceria nano particles with the size of 2-5 nm. Results demonstrate that the particle-size didn't change considerably with hours of dissolution. FIG. 6 displays two enhanced images of nanoparticles after the glass S6 was dissolved for (a) 7 hrs and (b) 2 hrs. Both micrographs show evidence of nano particles with atomic distances of (0.388±0.02) nm, (0.245±0.02) nm, and (0.422±0.02) nm confirming the presence Ce₂O₃ nano crystals and the measured inter atomic distances of (0.311±0.02) nm and (0.386±0.02) nm are in complete agreement to the lattice parameter of CeO₂. Results demonstrate that the ceria nanoparticle size didn't change considerably with hours of dissolution while the particles recovered after dissolved in DI water are in sizes ranged from (2.02±0.005) nm to (4.75±0.05) nm as shown in the high-resolution image in FIGS. 2(c) and 3(c).

### XANES Spectral Analysis

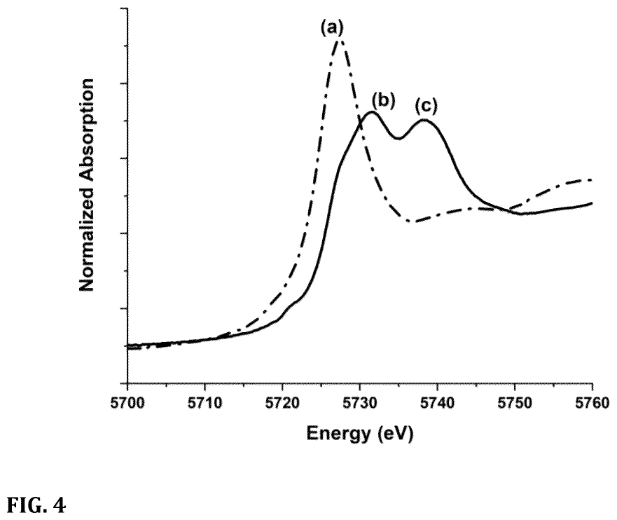

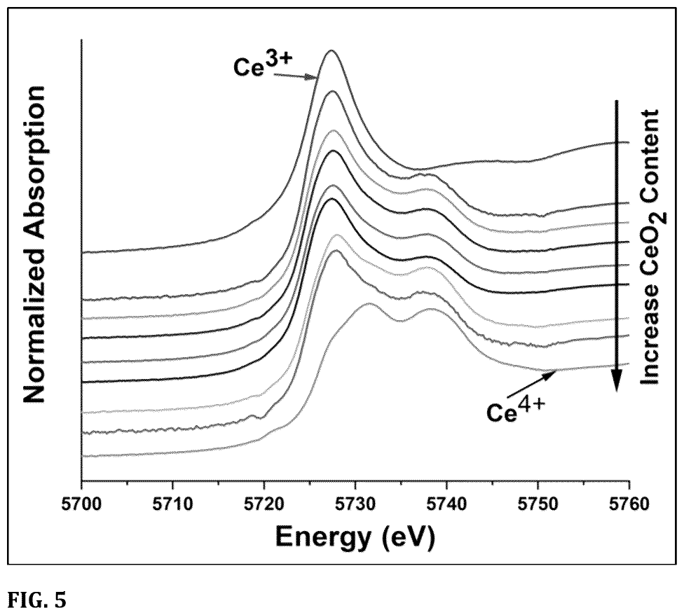

Glass compositions were studied with XANES via Ce L₃ edge and compared to compounds CeF₃ and CeO₂. Results shows trivalent (CeF₃—Ce³⁺) with a strong narrow single peak at 5727 eV while tetravalent reference (CeO₂—Ce⁴⁺) shows a multi-peak at 5731 eV and 5738 eV as shown in FIG. 4. FIG. 5 shows the XANES spectrum as the amount of CeO₂ in the glass increases for glass melted at 1100° C. for 1 hr. Glass S2 shows a higher Ce³⁺ peak while glass S5 shows a higher Ce⁴⁺ peak. The temperature and time effects on the redox states were observed and measured using the XANES spectra as shown in FIG. 6(a) for glass with 0.05 mol % of CeO₂ with borax used in the raw material. The Ce³⁺ peak height increased with increasing melting time when melted at 1100° C. When the glass was melted at different temperatures for 1 hr, the glasses meted at 1000° C. and 1300° C. had similar Ce³⁺ peak heights. The data, as indicated that the glass melted at 1100° C. 3 hr had the highest Ce³⁺ peak height out if all the melts. In order to further understand the different mechanisms of oxygen reduction of the glass, the glass sample with 0.05 mol % of CeO₂ was melted with different raw materials, such as borax, tetraborate, boric acid, and cerium fluoride. FIG. 6(b) shows the XANES spectra for the glass melted with different raw materials to obtain 0.05 mol % Ce. According to these results, the glass doped with CeF₃ had the higher Ce³⁺ concentration compared to the glass melted with CeO₂.

### FTIR Spectral Analysis

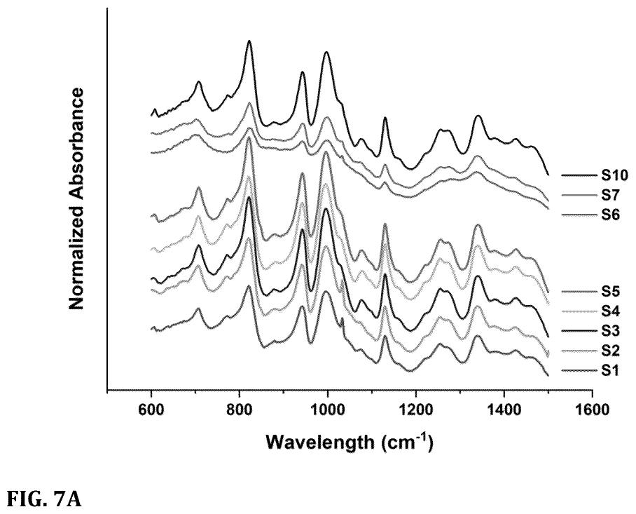

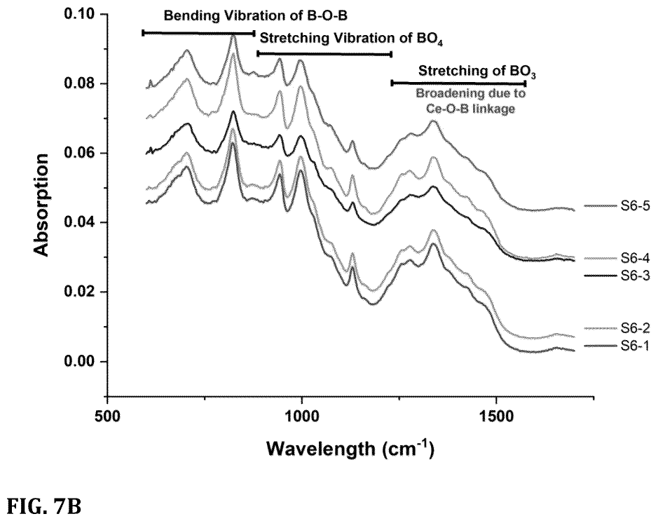

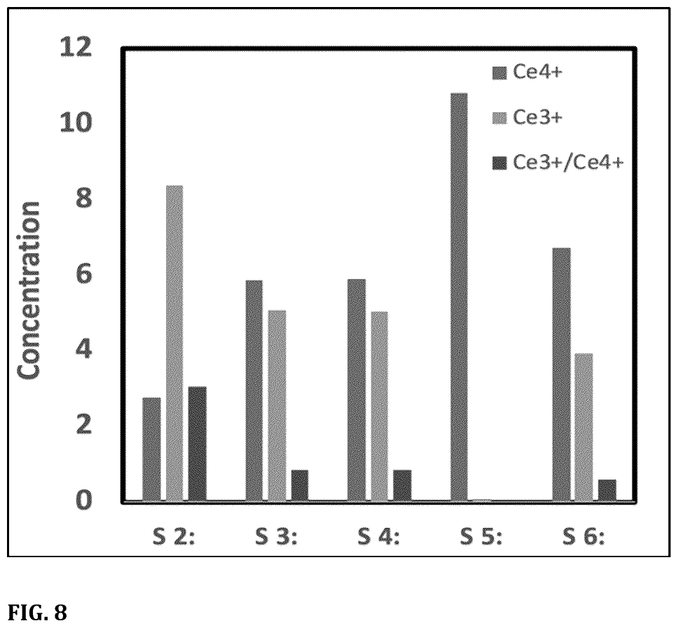

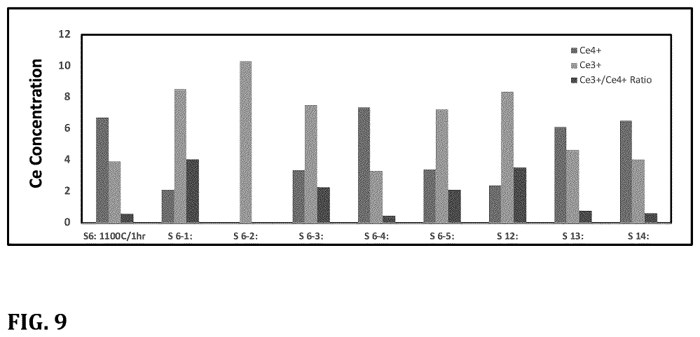

The FTIR spectra of S1 parent glass along with the glass sample of varying CeO₂ are shown in FIG. 7(a). Significant changes in the peaks were observed as the cerium content of the glass increases. IR spectra of the parent S1 glass shows a peaks between 600 cm⁻¹ to 850 cm⁻¹ are due to bending vibrations of various borate segments while the bending vibrations of the B—O—B linkage is shown by the small peak around 710 cm⁻¹. The spectral lines between 850 cm⁻¹ to 1200 cm⁻¹ attributes to B—O stretching vibrations of BO₄, while region of 1200 cm⁻¹-1500 cm⁻¹ B—O attributes to stretching vibrations of BO₃ units. Peaks around 775, 880, 1034, 1220, 1345 and 1432 cm⁻¹ seems to decrease in height as the cerium content in the glass increased and completely disappear in S6 glass, then starts to appear and increase in height when the cerium in the glass is further increased. Peaks 823, 936, 997, 1133, and 1226 cm⁻¹ increased in overall height with increasing the amount of cerium but rapidly decreased in height with 0.05 and 0.06 mols of CeO₂ and again increased in height with further increment of Ce. These results show that the glass containing 0.05 and 0.06 mols of CeO₂ of cerium is notably different from the rest of the glasses containing cerium and that of the parent glass.

### DISCUSSION

The glass containing Na₂O and B₂O₃ was mixed in with several different amounts CeO₂ to study the development of multivalent CeO₂ and Ce₂O₃ nano particles created within the glass due to different oxygen reduction conditions. The first set of data was obtained from changing the number of CeO₂ mols in small quantities, as 0-0.05 mols of CeO₂. The second set was obtained by changing the melting time and temperature while keeping doped amount of CeO₂ constant; 0.02 and 0.05 mols. The third set was obtained by introducing different raw materials to achieve different reduction status. The DSC micrographs shows that the melting temperature of these glasses are around 700° C. and the glass was melted at 400-600° C. above the melting point to achieve the full dissolution of CeO₂ and CeF₃ and a higher homogeneity. The optical micrographs conducted for all the glasses shows no evidence of undissolved CeO₂ particles. The DSC micrographs shows that the glass transition region is similar in all compositions even though T_{g} changes with the added CeO₂ amount. These samples had pronounced but different crystallization temperatures with a similar trend like T_{g} exhibiting an increase with added CeO₂ amount. The Glass-forming ability, which relates to the ease by which melts can be cooled to form glasses with the avoidance of crystal formation, remains similar to the parent glass as CeO₂ content increases since the glass transformation region and the glass melting temperature regions remains similar to each another. On the other hand, the glass stability, which was calculated using Hruby parameter, KH, differ as the amount of CeO₂ content increases as shown in Table 2. Glasses with higher K_{H} are stable against crystallization upon reheating, indicating changes in the glass network as the cerium content changes, which is confirmed by FTIR Spectroscopy. Glass composition with 0.05 mols of CeO₂ (S6, S13 and S14) have the highest stability against crystallization.

Strong evidence of the coexistence of multivalence CeO₂ and Ce₂O₃ nanoparticles was observed when the nanoparticles were recovered from these glasses by dissolving the powdered glass in DI water. As discussed earlier, the CeO₂ easily interchange to more reduced Ce₂O₃ by exchanging oxygen, creating a hexagonal structure from a more fluoride structure. High resolution FEI Tecnai 30 TEM measurements are in a very good agreement with the known atomic distances of CeO₂ and Ce₂O₃ structures. As shown in FIG. 3, the measured inter atomic distances of (0.311±0.02) nm are in complete agreement to the ideal lattice parameters of the cubic structure of CeO₂. Additionally, inter atomic distances of (0.388±0.02) nm and (0.386±0.02) nm are in complete agreement to the lattice parameter of A-type hexagonal structure of Ce₂O₃ (0001) plane interatomic distance of 0.3888 nm. The atomic distances (0.242±0.03) and (0.422±0.03) nm refers to (200) of and (101) planes of the hexagonal Ce₂O₃ nano particles. Both TEM micrographs shown in FIGS. 2(c) and 3(c) provide evidence of the coexistence of both types of cubic structure of CeO₂ and hexagonal Ce₂O₃ nano particle in the range of 2 to 5 nm in size. The shapes and the sizes of these particles are in very good agreement with the nano particles obtained by Day et al.

The results obtained from the XANES measurements using Ce L₃ edge confirms the coexistence of the two valences Ce³⁺ and Ce⁴⁺ in the glass when doped with CeO₂ (Ce⁴⁺). All the glasses measured via XANES were compared to compounds CeF₃ (Ce³⁺) and CeO₂. Results shows trivalent (Ce³⁺) with a strong narrow single peak as shown in FIG. 3 (a) due to 5d→4f emission while the tetravalent reference (Ce⁴⁺) shows a multi-peak. Peak (c) in FIG. 3, due to the transition where electron is exited from Ce 2p to 5d with no electron in the Ce 4f shell, while peak FIG. 3 (b) which is also a Ce⁴⁺ peak where final state is 2p4f15d1. In addition to an electron exited from the valence 2p to 5d, another electron is excited from the valence band of Oxygen 2p shell to Cerium 4f shell leaving a hole. None of the glass compositions exhibited this forbidden peak (b) which denotes that an electron is excited only from the Ce 2p shell to its 5d shell. These results were comparable to the results of Cicconi et. al. thus providing strong evidence of the coexistence of the both trivalent (Ce³⁺) and tetravalent (Ce⁴⁺) with in the glass. Out of all the glasses melted with B₂O₃, S2 glass melted with 0.01 mols of CeO₂ for 1100° C. for 1 hr had the highest amount of Ce⁴⁺ ions, while glass S6-2 melted with borax and 0.05 mols of CeO₂ for 1100° C. for 3 hr had the highest amount of Ce³⁺ ions out of all meted glass samples, reaching higher oxidization to reduced status. When the same composition of S 6 glass with 0.05 mol of CeO₂ is melted at different melting times, the Ce³⁺ concentration increases as the melting time increases as shown in FIG. 6(a). Glass melted at 1200° C. had the highest Ce⁴⁺ concentration. The Ce³⁺ concentration of S12 glass melted with CeF₃ (rich in Ce³⁺) is similar to S2 glass melted with different melting times using 0.01 mol of CeO₂—. Significant changes in the Ce³⁺ peak height was not observed when the same S6 glass composition was made with borax (S6-1), tetra borate (S13) and boric acid (S14) instead of using raw materials of B₂O₃ and Na₂CO₃ and melted for 1100° C. for 1 hr. Out of all the glasses made with borax, the S6-3 glass made with borax for 3 hrs had the highest amount of Ce³⁺ concentration.

Each of the glass samples except the glasses labeled S12-S14 were processed using B₂O₃ as part of the composition. Vitreous B₂O₃ consist of BO₃ unit associated to form Boroxol rings which produces a spectral band at 806 cm⁻¹ in the glassy matrix. The Na₂O present in the glass convert BO₃ units to BO₄ units. The peak at 1034 cm⁻¹ in the parent glass S1 is due to the bond stretching vibrations of BO₄ while 775 cm⁻¹ peak is comparable to the bind bending vibrations of BO₄. Spectral lines at 1345 and 1432 cm⁻¹ in the FTIR absorption spectra are comparable to B—O stretching of trigonal BO₃ units. The lack of a peak at 806 cm⁻¹ in the absorption spectra in any of the glass tested indicate that the glass network mainly consists of BO₃ units to BO₄ units at the expense of boroxol rings. However, adding CeO₂ to the glass network works much differently than adding alkali as discussed in Damwari et al. CeO₂ act as a glass modifier as well as a glass network former. Both BO₃ units to BO₄ units in the IR spectra of the S6 glass disappeared indicating a formation where BO₃ units would be used to form Ce—O—B units rather than BO₄ units. It has been investigated that the asymmetric stretching vibrations of Ce—O—B lies in the 400 and 1370 cm⁻¹. All the glasses formed from 0.05 mol of cerium oxide, S6-1 to S6-5 show the same significant difference that the S6 glass shown in the IR spectra with a peak broadening from 1200 to 1600 cm⁻¹ as shown in FIG. 7(b). This could be due to the existence of both active bands of Ce—O—B and B—O—B links overlapping in this series of glass. The formation of Ce—O—B link as a glass former is supported by the XANES data where glass with 0.05 mol (specially S6-2) showed the highest amount of oxygen reduction providing larger amount of non-bridging oxygen (NBO) in the glass, forming much stable Ce—O—B link.

### CONCLUSION

A soluble sodium borate glass containing varying amounts of cerium oxide that is stable against crystallizations was successfully prepared with both trivalent Ce³⁺ (Ce₂O₃) and tetravalent Ce⁴⁺ (CeO₂) states. Cerium oxide nano particles were released when these glasses were dissolved in DI water. The TEM data provides strong evidence of coexistence of both types of cubic structure of CeO₂ (tetravalent Ce⁴⁺) and hexagonal Ce₂O₃ (trivalent Ce³⁺) nano particles. The concentrations of Ce³⁺ and Ce⁴⁺ in these glasses were determined using XANES Ce L₃ edge x-ray absorption spectroscopy. The XANES results also confirmed the coexistence of Ce³⁺ and Ce⁴⁺ valences in a series glasses with different concentrations of CeO₂ (Ce⁴⁺) melted with different temperatures, times, and raw materials. The Ce³⁺ and Ce⁴⁺ amounts significantly differed as the amounts of CeO₂ changed as well as with changes in melting time, temperature and raw materials. Glass S6-2 with 0.05 mol % CeO₂ had the maximum amount of Ce₂O₃(Ce³⁺) while glass S5 with 0.04 mol % CeO₂ had the maximum amount of CeO₂ (Ce⁴⁺). The results of this work also confirmed that the cerium oxide in the glass acts as both network modifier and network former. Cerium in the glass contained higher order Ce³⁺ act as a glass network former by creating a Ce—O—B link instead of BO₄ units while the glass with higher concentration of Ce⁴⁺ use cerium as a network modifier by creating BO₄ units from BO₃ units with increasing addition of CeO₂.

Borate glass containing varying amounts of cerium oxide was successfully prepared with both trivalent Ce³⁺ (Ce₂O₃) and tetravalent Ce⁴⁺ (CeO₂) states nano particles with 2-5 nm in size and the Ce⁺³ and Ce⁺⁴ concentrations of these glass compositions was determined using XANES CeL₃ edge x-ray absorption spectroscopy. The results confirmed the coexistence of Ce⁺³ and Ce⁺⁴ valances in a series glass with different compositions. The Ce⁺³ and Ce⁺⁴ amounts significantly differed as the amounts of CeO₂ changed as well as with changes in melting time, temperature and raw materials. The glass S6-2 with 0.05 mol % CeO₂ had the maximum amount of Ce₂O₃(Ce³⁺) while the glass S5 with 0.04 mol % CeO₂ had the maximum amount of CeO₂ (Ce⁴⁺). The results of this experiment also confirmed that the cerium oxide in the glass acts as both network modifier and network former. Cerium in the glass contained higher order Ce⁺³ act as a glass network former by creating a Ce—O—B link instead of BO₄ units while the glass with higher concentration of Ce⁺⁴ use cerium as a network modifier by creating BO₄ units from BO₃ units with increasing addition of CeO₂.

1.-20. (canceled)

21. A method of forming a composition comprising glass containing both trivalent cerium oxide and tetravalent cerium oxide states nanoparticles, the method comprising:
heating a raw material comprising CeO₂ to a temperature above the melting point of the raw material, wherein the temperature is between 1100° C. and 1300° C., including the end points;
maintaining the temperature for a specified amount of time; and
cooling the melted raw material to form the glass, wherein the glass contains a ratio of the trivalent cerium oxide and tetravalent cerium oxide states nanoparticles that is controlled and sealed within the glass.

22. The method of claim 21, wherein the raw material comprises 0.01 to 0.09 mol % CeO₂.

23. The method of claim 21, wherein the glass comprises a sodium borate glass.

24. The method of claim 21, wherein the nanoparticles each have a size between 2 and 5 nm.

25. The method claim 21, wherein the raw material comprises CePO₄ or Ce(NO₃)₃, or a combination thereof.

26. The method of claim 21, wherein the temperature is between 1200° C. and 1300° C., including the end points.

27. The method of claim 21, wherein the temperature is maintained for between 1 and 24 hours, including the end points.

28. The method of claim 21, wherein the temperature is 400-600° C. above the melting point of the raw material.

29. The method of claim 21, further comprising adding reducing agents to increase Ce³⁺ or adding oxidizing chemicals to reduce Ce³⁺.

30. The method of claim 21, wherein cerium oxide nanoparticles are configured to be released when the glass is dissolved.

31. A method of forming a soluble sodium borate glass comprising cerium oxide nanoparticles that is stable against crystallizations, the cerium oxide comprising both trivalent Ce³⁺ (Ce₂O₃) nanoparticles and tetravalent Ce⁴⁺ (CeO₂) nanoparticles, the method comprising:
modulating one or more synthesis parameters of the soluble sodium borate glass to achieve a controlled ratio of the trivalent Ce³⁺ (Ce₂O₃) and the tetravalent Ce⁴⁺ (CeO₂) nanoparticles by:
melting a raw material at a temperature;
maintaining the temperature for a specified amount of time; and
cooling the melted raw material to form the soluble sodium borate glass.

32. The method of claim 31, wherein cerium oxide nanoparticles are configured to be released when the glass is dissolved.

33. The method of claim 31, further comprising doping the sodium borate glass with Ce₂O to produce the trivalent Ce³⁺ (Ce₂O₃) nanoparticles and tetravalent Ce⁴⁺ (CeO₂) nanoparticles.

34. The method of claim 31, wherein the nanoparticles each have a size between 2 and 5 nm.

35. The method of claim 31, wherein the glass is formed from a raw material comprising 0.01 to 0.09 mol % CeO₂.

36. The method of claim 31, wherein the raw material comprises 0.01 to 0.09 mol % CeO₂.

37. The method of claim 31, wherein the temperature is between 1000° C. and 1300° C. including the end points.

38. The method of claim 31, wherein the temperature is maintained between 1 and 24 hours including the end points.

39. The method of claim 31, wherein the temperature is 400-600° C. above the melting point of the raw material.

40. The method of claim 31, further comprising adding reducing agents to increase Ce³⁺ or adding oxidizing chemicals to reduce Ce³⁺.
